(19) United States
(12) Patent Application Publication
(10) Pub. No.: US 2014/0114890 A1
(43) Pub. Date: Apr. 24, 2014

(54) PROBABILITY MODEL ESTIMATION DEVICE, METHOD, AND RECORDING MEDIUM

(71) Applicants: Ryohei Fujimaki, Tokyo (JP); Satoshi Morinaga, Tokyo (JP); Masashi Sugiyama, Tokyo (JP)

(72) Inventors: Ryohei Fujimaki, Tokyo (JP); Satoshi Morinaga, Tokyo (JP); Masashi Sugiyama, Tokyo (JP)

(21) Appl. No.: 14/122,533

(22) PCT Filed: May 24, 2012
(86) PCT No.: PCT/JP2012/064010

§ 371 Date: Nov. 26, 2013

(30) Foreign Application Priority Data
May 30, 2011 (JP) 2011-119859

(51) Int. Cl. G06N 99/00

(52) U.S. Cl. CPC G06N 99/005
USPC 706/12

(57) ABSTRACT

In order to learn an appropriate probability model in a probability model learning problem where a first issue and a second issue manifest concurrently by solving the two at the same time, provided is a probability model estimation device for obtaining a probability model estimation result from first to T-th (T≧2) training data and test data. The probability model estimation device includes: first to T-th training data distribution estimation processing units for obtaining first to T-th training data marginal distributions with respect to the first to the T-th training models, respectively; a test data distribution estimation processing unit for obtaining a test data marginal distribution with respect to the test data; first to T-th density ratio calculation processing units for calculating first to T-th density ratios, which are ratios of the test data marginal distribution to the first to the T-th training data marginal distributions, respectively; an objective function generation processing unit for generating an objective function that is used to estimate a probability model from the first to the T-th density ratios; and a probability model estimation processing unit for estimating the probability model by minimizing the objective function.

### TECHNICAL FIELD

This invention relates to a probability model learning device, and more particularly, to a method and device for estimating a probability model and a recording medium.

### BACKGROUND ART

The probability model is a model that expresses the distribution of data stochastically, and is applied to various industrial fields. Examples of the application of stochastic discrimination models and stochastic regression models, which are the subject of this invention, include image recognition (facial recognition, cancer diagnosis, and the like), trouble diagnosis based on a machine sensor, and risk assessment based on medical data.

Usual probability model learning based on maximum likelihood estimation, Bayesian estimation, or the like is built on two main assumptions. A first assumption is that data used for the learning (hereinafter referred to as “training data”) is obtained from the same information source. A second assumption is that the properties of the information source are the same for the training data and data that is the target of the prediction (hereinafter referred to as “test data”). In the following description, learning a probability model properly under a situation where the first assumption is not true is referred to as “the first issue” and learning a probability model properly under a situation where the second assumption is not true is referred to as “the second issue”.

However, both the first assumption and the second assumption are not true in, for example, automobile trouble diagnosis, where sensor data obtained from a plurality of vehicles of different types does not have the same information source, and the properties of an automobile change between the time when the training data is obtained and the time when the test data is obtained due to changes with time of the engine and the sensor. To give another example, medical data of people who differ in age and sex does not have the same information source and, in the case where a probability model that has been learned from data of the “specific health checkup” (provided to people aged 40 and up in Japan as a measure against lifestyle-related diseases) is applied to people in their thirties, the properties change between the training data and the test data, with the result that the first assumption and the second assumption are false again.

When the first assumption and the second assumption are not true in actuality, conditions that are the premise of maximum likelihood estimation, Bayesian estimation, or a similar learning technology are not established and, consequently, an appropriate probability model cannot be learned. Several methods have been proposed to solve this problem.

Regarding the first issue, a problem of learning a probability model of a target information source from data having different information sources is called transfer learning or multi-task learning, and various methods including that of Non Patent Literature 1 have been proposed. As to the second issue, the problem of changes in information source properties that are observed between the training data and the test data is called covariate shift, and various methods including that of Non Patent Literature 2 have been proposed.

However, the conventional technologies handle the first issue and the second issue separately, which means that, while proper learning is achieved for the individual issues, learning an appropriate model is difficult under a situation where the first issue and the second issue manifest concurrently as in the automobile trouble diagnosis and medical data learning described above. In addition, the two technologies have similar functions with which the training data is input and a probability model is output, and have difficulties in handling a simple combination such as utilizing the result of transfer learning as an input of a learning machine that takes covariate shift into account.

### CITATION LIST

### Non Patent Literature

Non Patent Literature 1: T. Evgeniou and M. Pontil. “Regulated Multi-Task Learning.” Proceedings of the Tenth ACM SIGKDD International Conference on Knowledge Discovery and Data Mining, p. 109-117, 2004
Non Patent Literature 2: M. Sugiyama, S. Nakajima, H. Kashima, P. von Bunau, and M. Kawanabe. “Direct Importance Estimation with Model Selection and Its Application to Covariate Shift Adaption.” Advances in Neural Information Processing Systems 20, p. 1433-1440, 2008

### SUMMARY OF THE INVENTION

### Problem to be Solved by the Invention

An object to be attained by this invention is to learn an appropriate probability model in a probability model learning problem where a first issue and a second issue manifest concurrently by solving the two at the same time.

### Means to Solve the Problem

This invention in particular has two features, which are 1) learning a probability model of a target information source by utilizing data that is obtained from a plurality of information sources, and 2) learning an appropriate probability model when utilizing a learned model in the case where the properties of an information source differ at the time of obtainment of the training data and at the time of utilization of the learned model.

Specifically, according to a first aspect of this invention, there is provided a probability model estimation device for obtaining a probability model estimation result from first to T-th (T≧2) training data and test data, including: a data inputting device for inputting the first to the T-th training data and the test data; first to T-th training data distribution estimation processing units for obtaining first to T-th training data marginal distributions with respect to the first to the T-th training models, respectively; a test data distribution estimation processing unit for obtaining a test data marginal distribution with respect to the test data; first to T-th density ratio calculation processing units for calculating first to T-th density ratios, which are ratios of the test data marginal distribution to the first to the T-th training data marginal distributions, respectively; an objective function generation processing unit for generating an objective function that is used to estimate a probability model from the first to the T-th density ratios; a probability model estimation processing unit for estimating the probability model by minimizing the objective function; and a probability model estimation result producing device for producing the estimated probability model as the probability model estimation result.

Further, according to a second aspect of this invention, there is provided a probability model estimation device for obtaining a probability model estimation result from first to T-th (T≧2) training data and test data, including: a data inputting device for inputting the first to the T-th training data and the test data; first to T-th density ratio calculation processing units for calculating first to T-th density ratios, which are ratios of a marginal distribution of the test data to marginal distributions of the first to the T-th training models, respectively; an objective function generation processing unit for generating an objective function that is used to estimate a probability model from the first to the T-th density ratios; a probability model estimation processing unit for estimating the probability model by minimizing the objective function; and a probability model estimation result producing device for producing the estimated probability model as the probability model estimation result.

### Advantageous Effects of the Invention

According to this invention, the first issue and the second issue are solved at the same time and an appropriate probability model can be learned.

### BRIEF DESCRIPTION OF THE DRAWING

FIG. 1 is a block diagram illustrating a probability model estimation device according to a first exemplary embodiment of this invention;

FIG. 2 is a flow chart illustrating the operation of the probability model estimation device of FIG. 1;

FIG. 3 is a block diagram illustrating a probability model estimation device according to a second exemplary embodiment of this invention; and

FIG. 4 is a flow chart illustrating the operation of the probability model estimation device of FIG. 3.

### MODE FOR EMBODYING THE INVENTION

Some of symbols used herein to describe embodiment modes of this invention are defined. First, X and Y represent stochastic variables that are an explanatory variable and an explained variable, respectively. P(X; θ), P(Y, X; θ, ø), and P(Y|X; ø) respectively represent the marginal distribution of X, the simultaneous distribution of X and Y, and the conditional distribution of Y with X as a condition (θ and ø each represent a distribution parameter). Parameters may be omitted for the sake of simplifying notation.

Because different information sources result in different probability models, and a probability model at the time of training and a probability model at the time of test differ from each other, P^{tr}ₜ(X) and P^{te}ₜ(X) represent an explanatory variable distribution at the time of training in a t-th training information source (hereinafter referred to as the t-th training information source t. t=1, . . . , T) and an explanatory variable distribution at the time of test, respectively. It is assumed that the distribution P(Y|X; ø) does not change at the time of training and at the time of test as in the conventional covariate shift problem. P(Y|X; øᵤₜ) represents a parameter learned in the t-th training information source in order to learn a probability model of a test information source u.

Training data corresponding to X and training data corresponding to Y that are obtained in the t-th training information source t are respectively denoted by x^{tr}ₜₙ, and y^{tr}ₜₙ, (n=1, . . . , N^{tr}ₜ. A target information source is the test information source u, and (an explanatory variable of) test data corresponding to X that is obtained in the test information source u is denoted by x^{te}ᵤₙ (n=1, . . . , N^{te}ᵤ.

A similarity between the t-th training information source t and the test information source u which is input along with data is denoted by Wᵤₜ. Wᵤₜ is defined by an arbitrary real value, for example, a binary value indicating whether the two are similar to each other or not, or a numerical value between 0 and 1.

### First Exemplary Embodiment

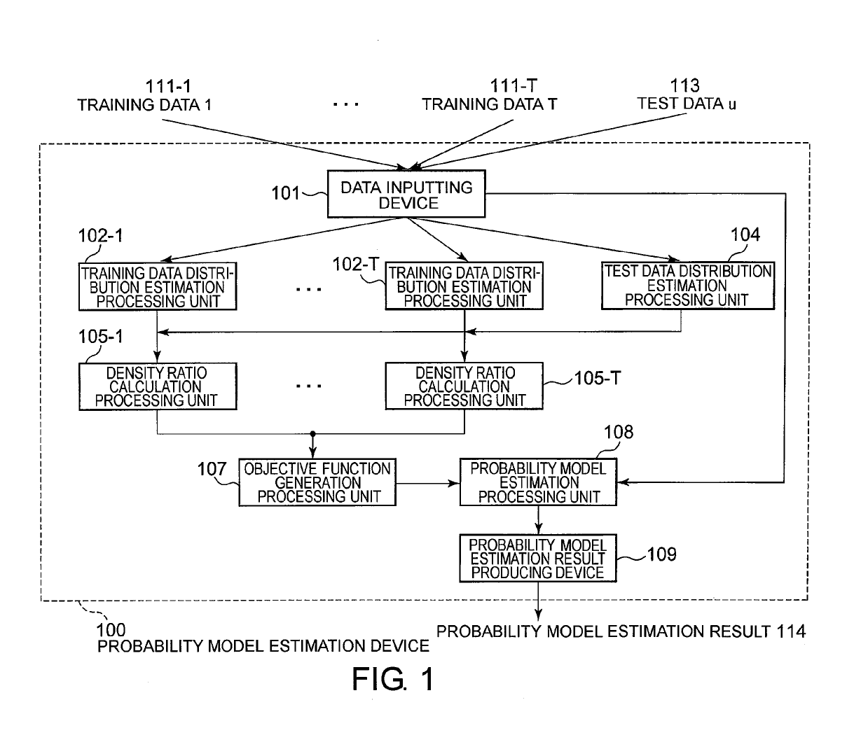

Referring to FIG. 1, a probability model estimation device 100 according to a first exemplary embodiment of this invention includes a data inputting device 101, first to T-th training data distribution estimation processing units 102-1 to 102-T (T≧2), a test data distribution estimation processing unit 104, first to T-th density ratio calculation processing units 105-1 to 105-T, an objective function generation processing unit 107, a probability model estimation processing unit 108, and a probability model estimation result producing device 109. The probability model estimation device 100 inputs first to T-th training data 1 to T (111-1 to 111-T) obtained from respective training information sources, estimates a probability model that is appropriate for a test environment of the test information source u, and produces the estimated model as a probability model estimation result 114.

The data inputting device 101 is a device for inputting the first training data 1 (111-1) to the T-th training data T (111-T) obtained from a first training information source to a T-th training information source, and test data u (113) obtained from the test information source u. At the time the training data and the test data are input, a parameter necessary for probability model learning and others are input as well.

The t-th training data distribution estimation processing unit 102-t (1≦t≦T) learns a t-th training data marginal distribution P^{tr}ₜ (X;θ^{tr}ₜ) with respect to the t-th training data. An arbitrary distribution such as normal distribution, contaminated normal distribution, or non-parametric distribution can be used as a model of P^{tr}ₜ (X;θ^{tr}ₜ). An arbitrary estimation method such as maximum likelihood estimation, moment matching estimation, or Bayesian estimation can be used to estimate θ^{tr}ₜ.

The test data distribution estimation processing unit 104 learns a test data marginal distribution P^{te}ᵤ (X;θ^{te}ᵤ) with respect to the test data u. The same models and estimation methods as those of P^{tr}ₜ (X;θ^{tr}ₜ) can be used for P^{te}ᵤ (X;θ^{te}ᵤ).

The t-th density ratio calculation processing unit 105-t calculates a t-th density ratio, which is the ratio of the estimated t-th training data marginal distribution P^{tr}ₜ (X;θ^{tr}ₜ) and the estimated test data marginal distribution P^{te}ᵤ (X;θ^{te}ᵤ) at a training data point. Specifically, the t-th density ratio calculation processing unit 105-t calculates the value of Vᵤₜₙ=P^{te}ᵤ (x^{tr}ₜₙ;θ^{te}ᵤ)/P^{tr}ₜ (x^{tr}ₜₙ; θ^{tr}ₜ) with respect to x^{tr}ₜₙ (n=1, . . . , N^{tr}ₜ). As θ^{tr}ₜ and θ^{te}ᵤ, parameters calculated by the t-th training data distribution estimation processing unit 102-t and the test data distribution estimation processing unit 104 are used.

The objective function generation processing unit 170 inputs the calculated t-th density ratio Vᵤₜₙ, and generates an objective function (optimization reference) for estimating a probability model that is calculated in this embodiment. The generated function is a reference that includes the following two references both:

a first reference in which the goodness of fit of the t-th training data t in the test environment of the test information source u is equalized for all test information sources (t=1, . . . , T); and

a second reference in which the input similarity between information sources and the distance between probability models of information sources are equalized.

Whether the reference is maximized or minimized is, mathematically speaking, simply the matter of inverting the plus sign or minus sign of the same value. Described below is therefore a case where the reference is minimized and a smaller value of the reference is better.

The first reference and the second reference are related to the first issue and the second issue as follows. The first reference is defined as the goodness of fit in the test environment of the test information source u, instead of the learning environment of each training information source, and is therefore a reference that is important in solving the second issue. The second reference expresses interaction between different information sources, and is a reference that is important in solving the first issue.

The following Expression (1) can be given as an example of the configurations of the first reference and the second reference.

A₁=Σ^{T}ₜ₌₁∫Lₜ(Y,X,φᵤₜ)P^{te}ᵤ(X,Y)dXdY+CΣ^{T}ₜ₌₁WᵤₜDᵤₜ (1)

In Expression (1), the first term of the right-hand side represents the first reference and the second term of the right-hand side represents the second reference (C represents a trade-off parameter of the first reference and the second reference). Lt(Y, X, øᵤₜ) is a function that expresses the goodness of fit, and can be, for example, a negative logarithmic likelihood −log P(Y|X; øᵤₜ) or a mean square error (Y−Y′)² (Y′ is defined as Y having P(Y|X; øᵤₜ) as the maximum value). Dᵤₜ is an arbitrary distance function of a distance between probability models of the test information source u and the t-th training information source t. Given as examples of Dᵤₜ are the Kullback-Leibler distance or other inter-distribution distances between P(Y|X; øᵤₜ) and P(Y|X; øᵤᵤ), and the square distance between parameters, (øᵤₜ−øᵤᵤ)², or other inter-parameter distances.

The objective function generation processing unit 107 generates the reference of Expression (1) as the following Expression (2).

$${A}_{2} = {\sum }_{t = 1}^{T} \frac{1}{{N}_{t}^{tr}} {\sum }_{n = 1}^{{N}_{t}^{tr}} {V}_{utn} {L}_{t} ( {y}_{tn}^{tr} , {x}_{tn}^{tr} , {φ}_{ut} ) + C {\sum }_{t = 1}^{T} {W}_{ut} {D}_{ut} \qquad ( 2 )$$

The basis of generating the reference of Expression (1) as Expression (2) is explained by the following Expression (3).

$$\begin{matrix}{A}_{1} = {\sum }_{t = 1}^{T} \int {L}_{t} ( Y , X , {φ}_{ut} ) \frac{{P}_{u}^{te} ( X )}{{P}_{t}^{tr} ( X )} {P}_{t}^{tr} ( Y , X ) d X d Y + \\ C {\sum }_{t = 1}^{T} {W}_{ut} {D}_{ut} \\ \approx {\sum }_{t = 1}^{T} \frac{1}{{N}_{t}^{tr}} {\sum }_{n = 1}^{{N}_{t}^{tr}} \frac{{P}_{u}^{te} ( {x}_{tn}^{tr} )}{{P}_{t}^{tr} ( {x}_{tn}^{tr} )} {L}_{t} ( {y}_{tn}^{tr} , {x}_{tn}^{tr} , {φ}_{ut} ) + C {\sum }_{t = 1}^{T} {W}_{ut} {D}_{ut} \\ = {A}_{2}\end{matrix} \qquad ( 3 )$$

Expression (3) utilizes the fact that an integral about a simultaneous distribution can be approximated by an average of samples owing to the law of large numbers.

The probability model estimation processing unit 108 uses an arbitrary method to minimize, with respect to øᵤₜ (t=1, . . . , T), the objective function A₂ (Expression (2)) generated by the objective function generation processing unit 107 and estimates a probability model. Examples of the minimization method include one in which candidates of øᵤₜ are generated as numerical values and the value of A₂ is checked for searching for the minimum value, and one in which a differential of A₂ is calculated with respect to øᵤₜ for searching for the minimum value by utilizing a gradient method such as the Newton's method. The probability model P(Y|X; øᵤᵤ) appropriate for the test information source u is learned in this manner.

The probability model estimation result producing device 109 produces the estimated probability model P(Y|X; øᵤₜ) (t=1, . . . , T) as the probability model estimation result 114.

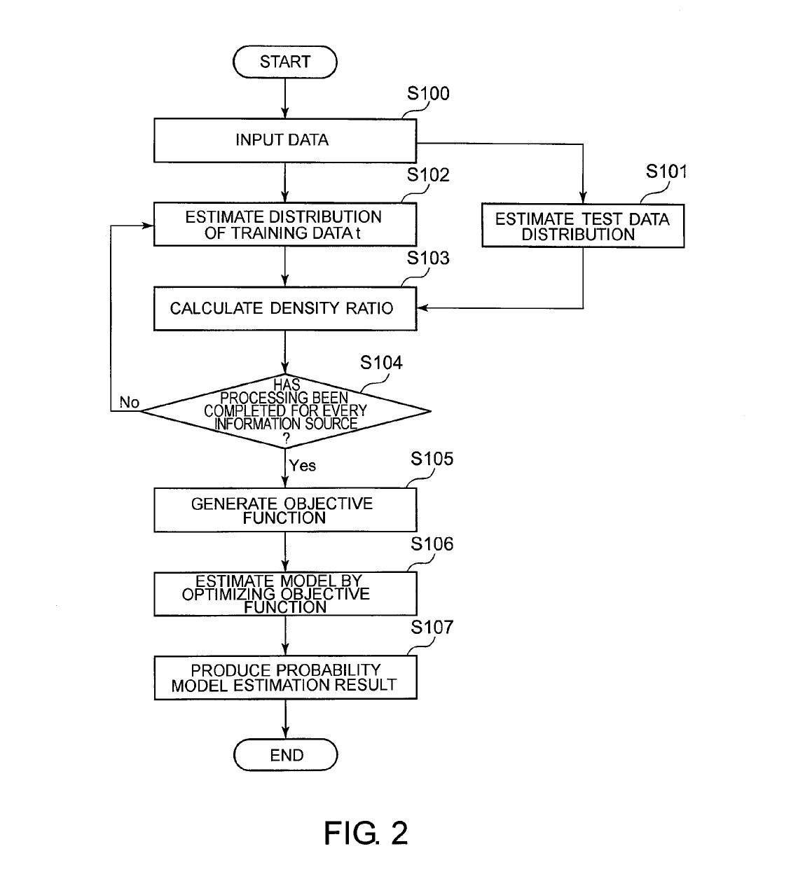

Referring to FIG. 2, the probability model estimation device 100 according to the first exemplary embodiment operates roughly as follows.

First, the first training data 1 (111-1) to the T-th training data T (111-T) and the test data u (113) are input by the data inputting device 101 (Step S100).

Next, the test data distribution estimation processing unit 104 learns (estimates) the test data marginal distribution P^{te}ᵤ (X; θ^{te}ᵤ) with respect to the test data u (Step S101).

The t-th training data distribution estimation processing unit 102-t learns the t-th training data marginal distribution P^{tr}ₜ (X; θ^{tr}ₜ) with respect to the t-th training data t (111-t) (Step S102).

The t-th density ratio calculation processing unit 105-t calculates the t-th density ratio Vᵤₜₙ (Step S103).

When the t-th density ratio Vᵤₜₙ has not been calculated for every training information source t (No in Step S104), Step S102 and Step S103 are repeated.

When the t-th density ratio Vᵤₜₙ has been calculated for every training information source t (Yes in Step S104), the objective function generation processing unit 107 generates an objective function that corresponds to Expression (2) (Step S105).

Next, the probability model estimation processing unit 108 optimizes the generated objective function to estimate the probability model P(Y|X; øᵤₜ) (Step S106).

Lastly, the probability model estimation result producing device 109 produces the estimated probability model (Step S107).

With the configuration described above, a probability model that takes into account the first issue and the second issue at the same time can be learned properly.

The probability model estimation device 100 can be implemented by a computer. As well known, a computer includes an input device, a central processing unit (CPU), a storage device (for example, a RAM) for storing data, a program memory (for example, a ROM) for storing a program, and an output device. By reading a program stored in the program memory (ROM), the CPU implements the functions of the first to the T-th training data distribution estimation processing units 102-1 to 102-T, the test data distribution estimation processing unit 104, the first to the T-th density ratio calculation processing units 105-1 to 105-T, the objective function generation processing unit 107, and the probability model estimation processing unit 108.

### Second Exemplary Embodiment

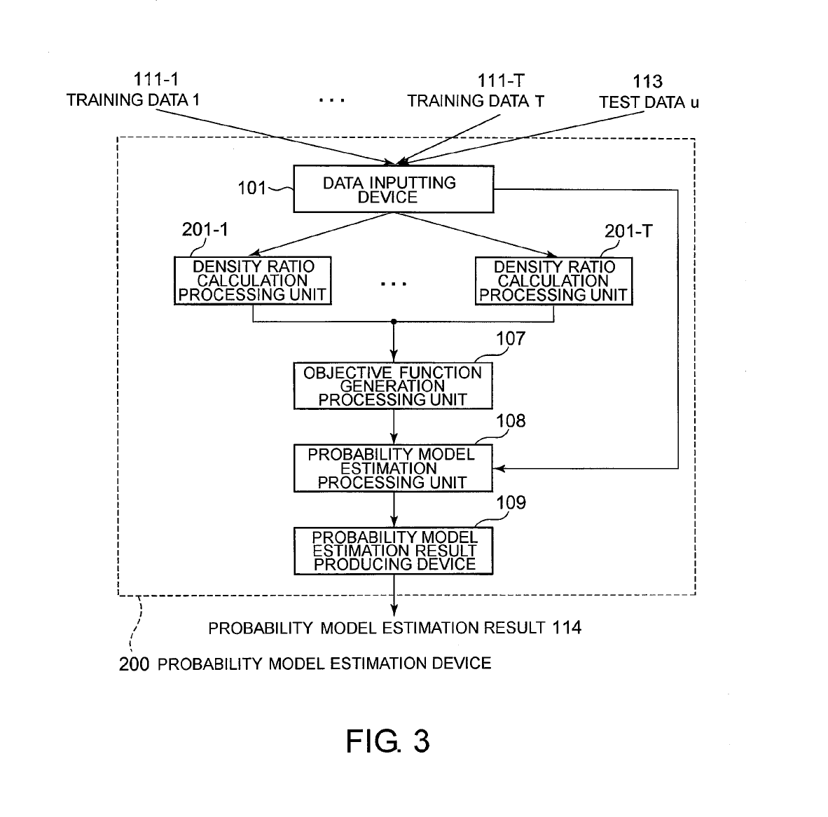

Referring to FIG. 3, a probability model estimation device 200 according to a second exemplary embodiment of this invention differs from the probability model estimation device 100 described above only in that the first training data distribution estimation processing unit 102-1 to the T-th training data distribution estimation processing unit 102-T and the test data distribution estimation processing unit 104 are not connected, and in that a first density ratio calculation processing unit 201-1 to a T-th density ratio calculation processing unit 201-T are connected in place of the first density ratio calculation processing unit 105-1 to the T-th density ratio calculation processing unit 105-T.

More specifically, the probability model estimation device 200 according to the second exemplary embodiment differs from the probability model estimation device 100 according to the first exemplary embodiment in how the t-th density ratio Vᵤₜₙ is calculated.

The t-th density ratio calculation processing unit 201-t estimates the t-th density ratio Vᵤₜₙ directly from the training data and the test data without calculating the training data distribution and the test data distribution. An arbitrary technology that has been proposed can be used for the estimation.

Calculating the density ratio directly without estimating the training data distribution and the test data distribution in this manner is known to improve the precision of density ratio estimation, which gives the probability model estimation device 200 an advantage over the probability model estimation device 100.

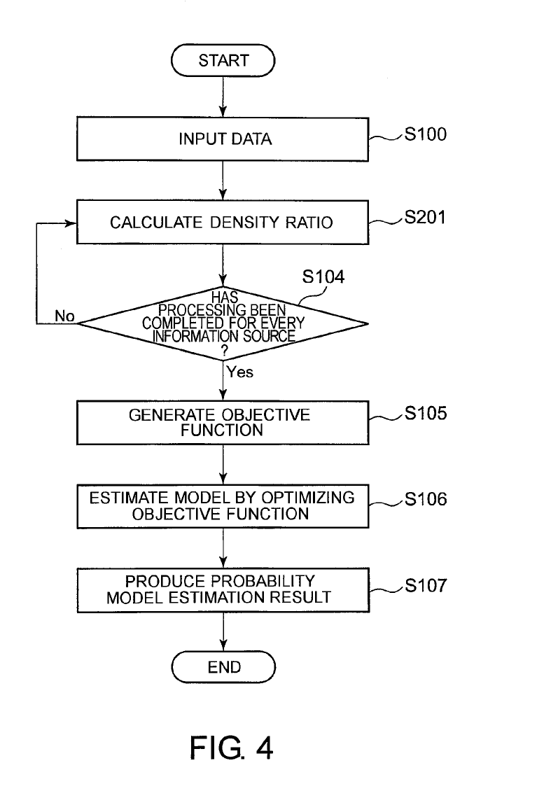

Referring to FIG. 4, the operation of the probability model estimation device 200 according to the second exemplary embodiment differs from the operation of the probability model estimation device 100 only in that the density ratio calculation of Steps S101 to S103 is replaced by the calculation of the t-th density ratio, which is executed in Step S201 by the t-th density ratio calculation processing unit 201-t.

The probability model estimation device 200 can also be implemented by a computer. As well known, a computer includes an input device, a central processing unit (CPU), a storage device (for example, a RAM) for storing data, a program memory (for example, a ROM) for storing a program, and an output device. By reading a program stored in the program memory (ROM), the CPU implements the functions of the first to the T-th density ratio calculation processing units 201-1 to 201-T, the objective function generation processing unit 107, and the probability model estimation processing unit 108.

### Example 1

Described next is an example in which the probability model estimation device 100 according to the first exemplary embodiment of this invention is applied to automobile trouble diagnosis. In this example, the t-th training information source t is a t-th vehicle type t, the training data is obtained in actual driving, and the test data is obtained from a test drive of an actual automobile. The first issue and the second issue manifest concurrently because the distribution and degree of correlation of sensors vary depending on the vehicle type, and the driving conditions obviously differ in a test drive and actual driving.

X includes the values of a first sensor 1 to a d-th sensor d (for example, the speed or the rpm of the engine), and Y is a variable that indicates whether a trouble has occurred or not.

The t-th training data distribution P^{tr}ₜ (X; θ^{tr}ₜ) and the test data distribution P^{te}ᵤ (X;θ^{te}ᵤ) are assumed to be multivariate normal distributions. The parameters θ^{tr}ₜ and θ^{te}ᵤ are calculated from the training data and the test data by maximum likelihood estimation. As a result, θ^{tr}ₜ is calculated as a mean vector and covariance matrix of x^{tr}ₜₙ, θ^{te}ᵤ is similarly calculated as a mean vector and covariance matrix of x^{te}ᵤₙ, and Vᵤₜₙ=P^{te}ᵤ(x^{tr}ₜₙ; θ^{te}ᵤ)/P^{tr}ₜ(x^{tr}ₜₙ; θ^{tr}ₜ) is calculated as the t-th density ratio thereof.

Next, P(Y|X; øᵤₜ) is assumed as a logistic regression model, a negative logarithmic likelihood −log P(Y|X; øᵤₜ) is used as Lt(Y, X, øᵤₜ), and the square distance between parameters, (øᵤₜ−øᵤᵤ)², is used as Dᵤₜ. Because Lt(Y, X, øᵤₜ) and Dᵤₜ are functions that can be differentiated with respect to the parameters, the local optimum of øᵤₜ can be calculated by a gradient method.

With this configuration, a case is considered in which, for example, u is defined as u=(T+1), the training data of the first vehicle type to the T-th vehicle type is actual driving data, data of the (T+1)-th vehicle type is test drive data, and the test environment is that of the (T+1)-th vehicle type. For a new car from which trouble data has not been obtained, a trouble diagnosis model appropriate for the (T+1)-th vehicle type can be learned from actual driving data of similar vehicle types (t=1, . . . , T) and test drive data of the (T+1)-th vehicle type.

It is obvious that the probability model estimation device 200 according to the second exemplary embodiment of this invention is applicable to automobile trouble diagnosis as well.

### INDUSTRIAL APPLICABILITY

This invention can be used in image recognition (facial recognition, cancer diagnosis, and the like), trouble diagnosis based on a machine sensor, and risk assessment based on medical data.

### REFERENCE SIGNS LIST

100 probability model estimation device
101 data inputting device
102-1 to 102-T training data distribution estimation processing unit
104 test data distribution estimation processing unit
105-1 to 105-T density ratio calculation processing unit
107 objective function generation processing unit
108 probability model estimation processing unit
109 probability model estimation result producing device
111-1 to 111-T training data
113 test data
114 probability model estimation result
200 probability model estimation device
201-1 to 201-T density ratio calculation processing unit
   This application is based upon and claims the benefit of priority from Japanese Patent Application No. 2011-119859, filed on May 30, 2011, the disclosure of which is incorporated herein in its entirety by reference.

1. A probability model estimation device for obtaining a probability model estimation result from first to T-th (T≧2) training data and test data, comprising:
a data inputting device inputting the first to the T-th training data and the test data;
first to T-th training data distribution estimation processing units obtaining first to T-th training data marginal distributions with respect to the first to the T-th training data, respectively;
a test data distribution estimation processing unit obtaining a test data marginal distribution with respect to the test data;
first to T-th density ratio calculation processing units far calculating first to T-th density ratios, which are ratios of the test data marginal distribution to the first to the T-th training data marginal distributions, respectively;
an objective function generation processing unit generating an objective function that is used to estimate a probability model from the first to the T-th density ratios;
a probability model estimation processing unit estimating the probability model by minimizing the objective function; and
a probability model estimation result producing device producing the estimated probability model as the probability model estimation result.

2. A probability model estimation device according to claim 1, wherein actual driving data of first to T-th vehicle types is supplied as the first to the T-th training data, test drive data of a (T+1)-th vehicle type is supplied as the test data, and a trouble diagnosis model for the (T+1)-th vehicle type is thereby produced as the probability model estimation result.

3. A probability model estimation method for obtaining a probability model estimation result from first to T-th (T≧2) training data and test data, the probability model estimation method comprising:
inputting the first to the T-th training data and the test data;
obtaining first to T-th training data marginal distributions with respect to the first to the T-th training data, respectively;
obtaining a test data marginal distribution with respect to the test data;
calculating first to T-th density ratios, which are ratios of the test data marginal distribution to the first to the T-th training data marginal distributions, respectively;
generating an objective function that is used to estimate a probability model from the first to the T-th density ratios;
estimating the probability model by minimizing the objective function; and
producing the estimated probability model as the probability model estimation result.

4. A non-transitory computer-readable recording medium having recorded thereon a probability model estimation program for causing a computer to obtain a probability model estimation result from first to T-th (T≧2) training data and test data,
wherein the probability model estimation program causes the computer to implement:
a data inputting function inputting the first to the T-th training data and the test data;
first to a T-th training data distribution estimation processing functions obtaining first to T-th training data marginal distributions with respect to the first to the T-th training data, respectively;
a test data distribution estimation processing function obtaining a test data marginal distribution with respect to the test data;
first to T-th density ratio calculation processing functions calculating first to T-th density ratios, which are ratios of the test data marginal distribution to the first to the T-th training data marginal distributions, respectively;
an objective function generation processing function generating an objective function that is used to estimate a probability model from the first to the T-th density ratios;
a probability model estimation processing function estimating the probability model by minimizing the objective function; and
a probability model estimation result producing function producing the estimated probability model as the probability model estimation result.

5. A probability model estimation device for obtaining a probability model estimation result from first to T-th (T≧2) training data and test data, comprising:
a data inputting device inputting the first to the T-th training data and the test data;
first to T-th density ratio calculation processing units calculating first to T-th density ratios, which are ratios of a marginal distribution of the test data to marginal distributions of the first the T-th training data, respectively;
an objective function generation processing unit generating an objective function that is used to estimate a probability model from the first to the T-th density ratios;
a probability model estimation processing unit estimating the probability model by minimizing the objective function; and
a probability model estimation result producing device for producing the estimated probability model as the probability model estimation result.

6. A probability model estimation device according to claim 5, wherein actual driving data of firs to T-th t vehicle types is supplied as the first to the T-th training data, test drive data of a (T+1)-th vehicle type is supplied as the test data, and a trouble diagnosis model for the (T+1)-th vehicle type is thereby produced as the probability model estimation result.

7. A probability model estimation method for obtaining a probability model estimation result from first training data to T-th (T≧2) training data and test data, comprising:
inputting the first to the T-th training data and the test data;
calculating first to T-th density ratios, which are ratios of a marginal distribution of the test data to marginal distributions of the first to the T-th training data, respectively;
generating an objective function that is used to estimate a probability model from the first to the T-th density ratios;
estimating the probability model by minimizing the objective function; and
producing the estimated probability model as the probability model estimation result.

8. A non-transitory computer-readable recording medium having recorded thereon a probability model estimation program for causing a computer to obtain a probability model estimation result from first to T-th (T≧2) training data and test data,
wherein the probability model estimation program causes the computer to implement:
a data inputting function inputting the first to the T-th training data and the test data;
first to T-th density ratio calculation processing functions calculating first to T-th density ratios, which are ratios of a marginal distribution of the test data to marginal distributions of the first to the T-th training data, respectively;
an objective function generation processing function generating an objective function that is used to estimate a probability model from the first to the T-th density ratios;
a probability model estimation processing function estimating the probability model by minimizing the objective function; and
a probability model estimation result producing function producing the estimated probability model as the probability model estimation result.
